(19) United States
(12) Patent Application Publication
(10) Pub. No.: US 2015/0304469 A1
(43) Pub. Date: Oct. 22, 2015

(54) PERSONAL COMMUNICATION DEVICE

(71) Applicants: JAVIER TENORIO CERVANTES, SAN PEDRO GARZA GARCIA (MX); VICTOR MANUEL TERAN AMOZORRUTIA, MONTERREY (MX)

(72) Inventors: JAVIER TENORIO CERVANTES, SAN PEDRO GARZA GARCIA (MX); VICTOR MANUEL TERAN AMOZORRUTIA, MONTERREY (MX)

(21) Appl. No.: 14/255,673

(22) Filed: Apr. 17, 2014

(51) Int. Cl. H04M 1/60; H04M 1/05

(52) U.S. Cl. CPC H04M 1/6033; H04M 1/05

(57) ABSTRACT

A light and hands-free auxiliary communication device for private conversations which provides the user the ability to have private conversations in public environments through the use of wave-inverting technology and wherein the device is characterized by comprising a front section which includes a wave-inverting technology system, and at least another section which is adapted to be rested on the top of the user ears or on the top of the user shoulders depending of its state of use, and which is joined to the front section and is characterized by being adapted to surround the user's neck.

### FIELD OF THE DISCLOSURE

The disclosure broadly relates to a personal communication device which is particularly useful for private phone conversations by providing elimination of sound interference from a user environment.

### BACKGROUND OF THE DISCLOSURE

The description will be mainly in terms of its applicability in environments where users are exposed to high levels of noise interference and wherein there is a need for a high level of discreetness when having a phone conversation that cannot be guaranteed due to the close proximity of the user with other people within the environment.

In recent years there has been a collaboration trend that have caused people to work in semi-private and public environments. Office buildings have changed to having more open collaborative spaces and communication technologies have allowed people to work from different locations, which are often public. Said collaboration trend has emphasized global mobility and collaboration and has also inherently sacrificed personal privacy.

There is a privacy concern when there is a need of having a confidential conversation in a public environment, and therefore, there have been prior attempts to use noise reduction and cancelling technologies for providing a private environment for confidential conversations.

The privacy concern has been solved before by the use of the noise cancelling concept, wherein an originally emitted sound wave is captured by a microphone and wherein said sound wave is inverted and emitted by a device, such as a speaker, to cancel the original wave. Said concept has been used before the 1950's for aerospace applications. More recently, wave-inverting technology has been used in music headphones, microphones and other similar devices.

Some attempts to implement wave-inverting technology systems for conversations are discussed in prior publications, such as U.S. Pat. No. 7,088,828 B1, and U.S. Pat. No. 8,170,229 B2, wherein both publications specify the need for having private phone conversations in a public environment and wherein both solve said need through the use of wave-inverting technology.

The actual need for communication assistance is wider than only being able to use noise cancelling technology, but there is a need for a light and hands-free device that creates a favorable acoustic environment for a confidential conversation and that enhances the mobility experience of the user.

It is therefore desirable to provide a device that allows the user to have a confidential conversation in a public environment while maintaining desired mobility-related requirements such as light-weight and hands-free capability.

### OBJECTS AND SUMMARY OF THE DISCLOSURE

The present disclosure overcomes the drawbacks of the current art by introducing an ergonomically designed device for having private conversations in public environments.

In a preferred embodiment, the device is comprised by at least two sections, wherein one of the sections is placed directly in front of the user's mouth when the device is in mode of use, and is characterized by having a wave-inverting technology and a remote-connection communication element, such as Bluetooth, in order for the user to be able to speak to the device while connected to a personal phone system.

The two sections may be made from any plastic or composite material as long as one of the sections is made from a material with sufficient flexibility to adapt different positions depending on the device state of use. In a preferred embodiment, the front section is made from a rigid material and the back section is made from a flexible material.

In the broader aspects of this disclosure, the two sections are joined together and are characterized by having different functions to optimize the aesthetic, weight and ergonomic of the device.

Both sections are joined together, wherein the rigid section represents the front and the flexible section represents the back of the device. Said flexible section allows the device to have two positions, either to be rested on the top of the user shoulders or to be rested on the top of the user ears. The front rigid section is designed to be placed, in one of the positions, exactly in front of the user mouth covering the mouth extension and therefore, being able to capture all sounds made with the mouth that the user may emit. The back flexible section is designed to be placed surrounding the user's neck independently of the other section position.

In an appropriate ergonomic design for a wearable device, the device is required to have the ability to be weared by the user in a hands-free manner, to allow the user to perform other duties while the device is either rested on the top of the user ears or rested on the top of the user shoulders.

It is therefore an object of the present disclosure to provide an ergonomically, hands-free and light weighted device in order for a user to have private conversations.

### BRIEF DESCRIPTION OF THE DRAWINGS

The above-mentioned and other features of this disclosure and the manner of obtaining them will become more apparent, and the disclosure itself will be best understood by reference to the following descriptions of assemblies and frames taken in conjunction with the accompanying figures, which are given as non-limiting examples only, in which:

FIG. 1 is a perspective view the device according to a preferred embodiment of the present disclosure,

FIG. 2 is a front view of the front section of the device according to a preferred embodiment of the present disclosure,

FIG. 3 is a back view of the front section of the device according to a preferred embodiment of the present disclosure,

FIG. 4 shows a schematic front view of the device according to another preferred embodiment of the present disclosure,

FIG. 5 shows a schematic view of the device according to one preferred embodiment of the present disclosure in mode of rest on the top of the user shoulders,

FIG. 6 shows a schematic view of the device according to one preferred embodiment of the present disclosure in mode of rest on the top of the user ears.

The exemplifications set out herein illustrate embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

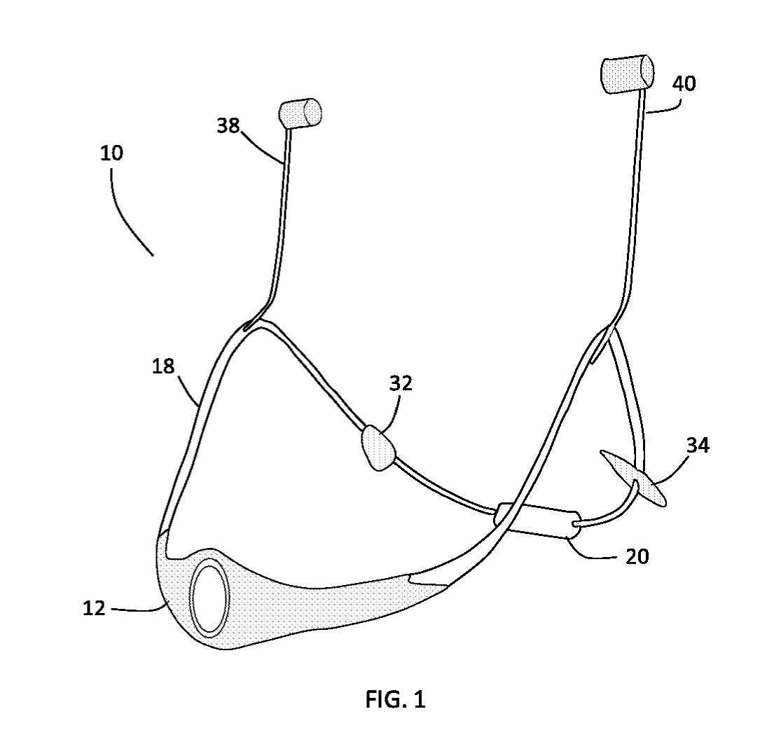

Referring to FIG. 1, a personal communication device (10) according a preferred embodiment of the present disclosure is shown, wherein said device (10) is comprised by at least 2 sections, a front rigid section (12) and a back more flexible section (18). The front section (12) and the back section (18) are joined together, temporarily or permanently, to form the device (10) and to have the ability to be placed surrounding the user's neck. According to a preferred invention, the device (10) comprises a pair of head phones (38, 40) to allow the user to have a phone conversation, a rechargeably battery (20), and a pair of vibrating elements (32, 34) that may work as alerting system to the user when the device is placed surrounding the user's neck.

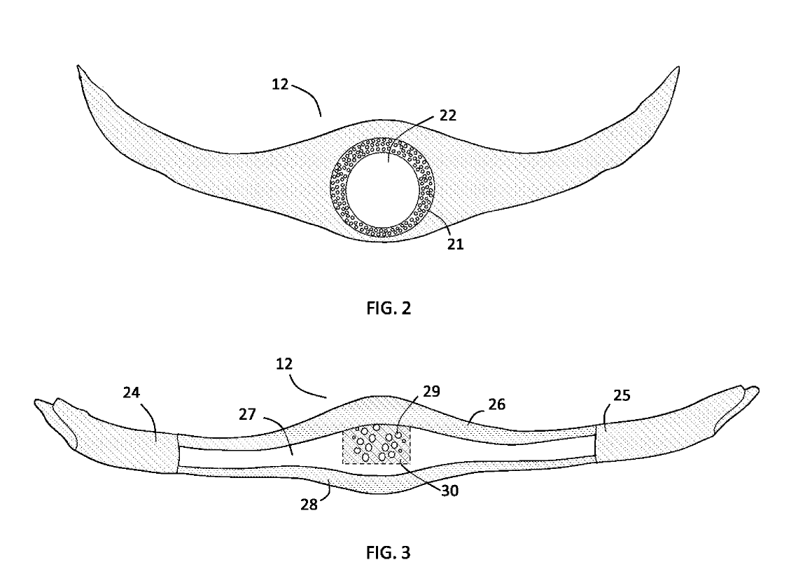

As shown on FIG. 2, the front rigid section (12) comprises a speaker (21) to emit the inverted sound waves that the user speaks when the system is placed in front of the user mouth and it is activated, and a display (22) that allows the device (10) to have additional interactive features such as displacing a message, light, color or any other visual stimulus allowed by a screen display. In a preferred embodiment of the present disclosure, the display (22) is placed in the center of the front rigid section (12).

FIG. 3 shows the back view of the front rigid section (12) which is the side that it is placed in front of the user's mouth when the device (10) is rested on the top of the user ears. In a preferred embodiment of the disclosure, the back of the front section (12) comprises surrounding elements (24, 25, 26, 28) which together form a cavity that surrounds the user's mouth when the device (10) is placed in front of the same. Additionally, the front rigid section (12) comprises the wave-inverting technology system elements such as a wave-inverter circuit (29) and a microphone (30).

The design of the present disclosure is intended to be shaped according to the communication needs of people in public environments, wherein the each part of the device (10) can be adapted to fit the user size and shape of head, neck and face in order to make said device functional for each user.

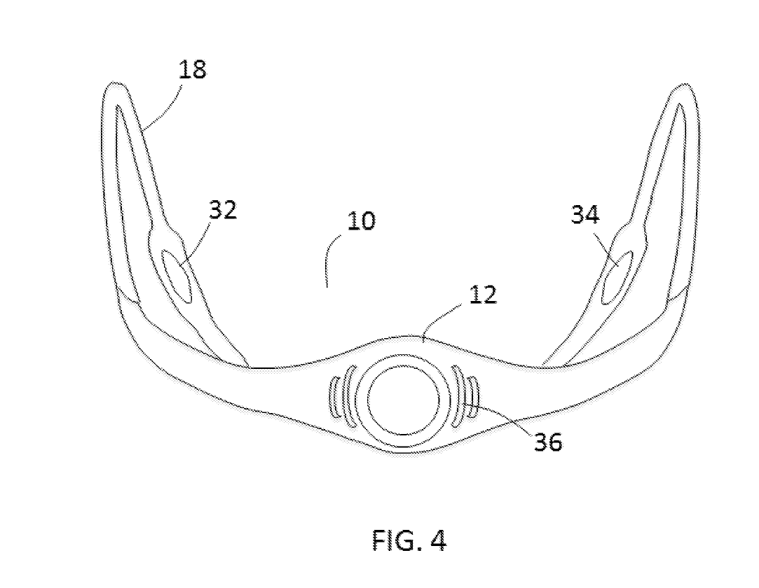

Referring to FIG. 4, a schematic front view of another preferred device (10) for the present disclosure is shown, wherein said device (10) comprises an additional display (36) that indicates whether the device is being used or not.

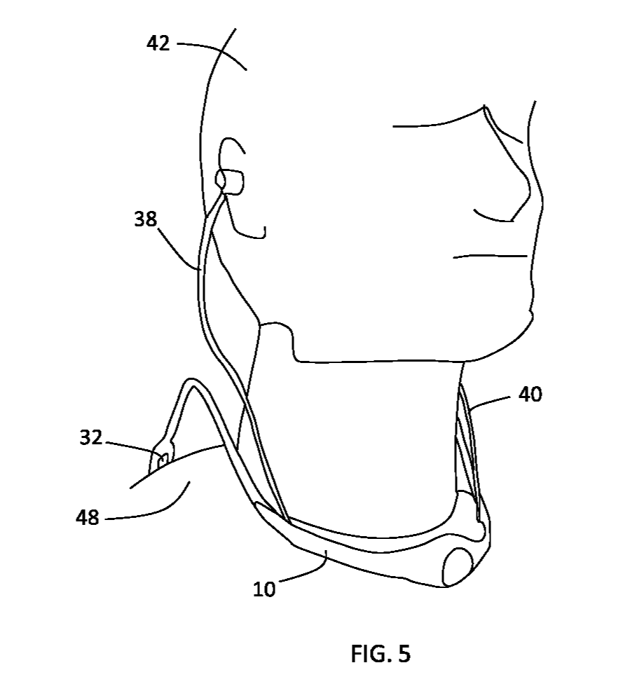

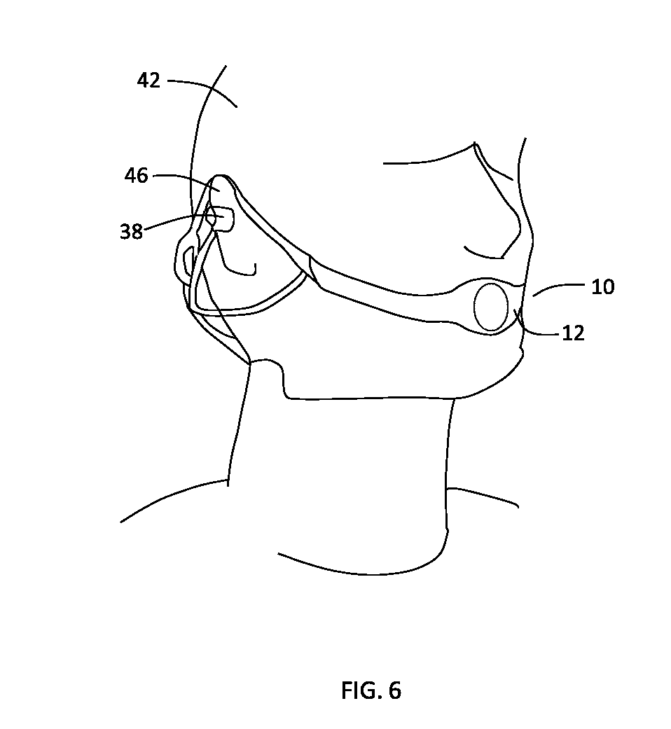

FIG. 5 shows a schematic view of the device (10) wherein the user (42) rests the device on the top of the shoulders (48) when the device (10) is not in use and wherein the vibrating elements (32) which are placed on the top of the user shoulders (48) and work as an alerting system to indicate through vibration when there are incoming phone calls and other desired alerts that might be programmed into the device's system.

FIG. 6 is a schematic view of the device (10) wherein the user (42) rests the device on the top of the ears (46) when the device (10) is in use and when the front section of the device (12) is placed directly in front of the user's mouth to capture all the sounds that the user's mouth may emit.

In both resting positions shown in FIG. 5 and FIG. 6, the device (10) has the ability to be provided with headphones (38, 40) in order for the user (42) to have the ability to have a phone conversation or to hear any other desired sound, such as music, which is sent through the activation of a remote connection communication such as Bluetooth.

1. A device (10) adapted as an auxiliary communication gadget comprising at least two sections, wherein
A front section (12) includes a wave-inverting technology system, and
At least another section (18) which is adapted to be rested on the top of the user ears or on the top of the user shoulders depending of its state of use, and which is joined to the front section (12) and is characterized by being adapted to surround the user's neck.

2. The device of claim 1 (10) wherein the wave-inverting technology system of the front section (12) includes a microphone (29), a wave-inverter (30) and a speaker (22).

3. The device of claim 1 (10) wherein the front section (12) is characterized by having at least one auxiliary display (36) to indicate that the device is in use.

4. The device of the claim 1 (10) wherein said device is characterized by having two vibrating elements (32, 34).

5. The device of claim 1 (10) wherein said device is characterized by having at least 1 auxiliary input for headphones.

6. The device of claim 1 (10) wherein said device includes a battery (20) to provide power to the device active systems.
